(19) United States
(12) Patent Application Publication
(10) Pub. No.: US 2017/0060434 A1
(43) Pub. Date: Mar. 2, 2017

(54) TRANSACTION-BASED HYBRID MEMORY MODULE

(71) Applicant: SAMSUNG ELECTRONICS CO., LTD., Suwon-si (KR)

(72) Inventors: Mu-Tien CHANG, San Jose, CA (US); Hongzhong ZHENG, Sunnyvale, CA (US); Dimin NIU, Sunnyvale, CA (US)

(21) Appl. No.: 14/947,145

(22) Filed: Nov. 20, 2015

Related U.S. Application Data
(60) Provisional application No. 62/210,939, filed on Aug. 27, 2015.

(51) Int. Cl. G06F 3/06; G06F 12/10; G06F 12/08

(52) U.S. Cl. CPC G06F 3/0608; G06F 12/0802; G06F 12/1009; G06F 3/061; G06F 3/0656; G06F 3/0658; G06F 3/0679; G06F 2212/1016; G06F 2212/1041; G06F 2212/2022; G06F 2212/22; G06F 2212/305

(57) ABSTRACT

A hybrid memory module includes a dynamic random access memory (DRAM) cache, a flash storage, and a memory controller. The DRAM cache includes one or more DRAM devices and a DRAM controller, and the flash storage includes one or more flash devices and a flash controller. The memory controller interfaces with the DRAM controller and the flash controller.

### CROSS-REFERENCE TO RELATED APPLICATION(S)

This application claims the benefits of and priority to U.S. Provisional Patent Application Ser. No. 62/210,939 filed Aug. 27, 2015, the disclosure of which is incorporated herein by reference in its entirety.

### TECHNICAL FIELD

The present disclosure relates generally to memory modules and, more particularly, to transaction-based hybrid memory modules.

### BACKGROUND

A solid-state drive (SSD) stores data in a non-rotating storage medium such as a dynamic random-access memory (DRAM) and a flash memory. DRAMs are fast, have a low latency and high endurance to repetitive read/write cycles. Flash memories are typically cheaper, do not require refreshes, and consumes less power. Due to their distinct characteristics, DRAMs are typically used to store operating instructions and transitional data, whereas flash memories are used for storing application and user data.

DRAM and flash memory may be used together in various computing environments. For example, datacenters require a high capacity, high performance, low power, and low cost memory solution. Today's memory solutions for datacenters are primarily based on DRAMs. DRAMs provide high performance, but flash memories are denser, consume less power, and cheaper than DRAMs.

Due to the differences in operational principle, separate memory controllers are used to control DRAMs and flash memories. For example, DRAM is byte addressable whereas flash memory is block addressable. The flash memory requires wear-leveling and garbage collection, whereas DRAM memory requires refresh. Further, for example, a hybrid memory system including both a DRAM and a flash memory requires an interface for data transmission between the DRAM and the flash memory. In addition, the hybrid memory requires a mapping table for data transmission between the DRAM and the flash memory. The address mapping between the DRAM and the flash memory may cause an overhead when saving and transmitting data. As a result, the performance of the hybrid memory system may degrade due to the overhead.

### SUMMARY

According to one embodiment, a hybrid memory module includes a dynamic random access memory (DRAM) cache, a flash storage, and a memory controller. The DRAM cache includes one or more DRAM devices and a DRAM controller, and the flash storage includes one or more flash devices and a flash controller. The memory controller interfaces with the DRAM controller and the flash controller.

According to one embodiment, a method for operating a hybrid memory module including a DRAM cache and a flash storage is disclosed. The method includes: receiving a memory transaction request from a host memory controller; storing the memory transaction request in a buffer of the hybrid memory module; checking a cache tag of the hybrid memory module and determining that the memory transaction request includes a request to access the DRAM cache; and performing the memory transaction request based on the cache tag.

The above and other preferred features, including various novel details of implementation and combination of events, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments without departing from the scope of the present disclosure.

### BRIEF DESCRIPTION OF THE DRAWINGS

The accompanying drawings, which are included as part of the present specification, illustrate the presently preferred embodiment and together with the general description given above and the detailed description of the preferred embodiment given below serve to explain and teach the principles described herein.

FIG. 1 shows an architecture of an example hybrid memory module, according to one embodiment;

FIG. 2A is an example flowchart for a read hit operation, according to one embodiment;

FIG. 2B is an example flowchart for a read miss operation, according to one embodiment;

FIG. 3A is an example flowchart for a write hit operation, according to one embodiment; and

FIG. 3B is an example flowchart for a write miss operation, according to one embodiment.

The figures are not necessarily drawn to scale and elements of similar structures or functions are generally represented by like reference numerals for illustrative purposes throughout the figures. The figures are only intended to facilitate the description of the various embodiments described herein. The figures do not describe every aspect of the teachings disclosed herein and do not limit the scope of the claims.

### DETAILED DESCRIPTION

Each of the features and teachings disclosed herein can be utilized separately or in conjunction with other features and teachings to provide a transaction-based hybrid memory module and a method of operating the same. Representative examples utilizing many of these additional features and teachings, both separately and in combination, are described in further detail with reference to the attached figures. This detailed description is merely intended to teach a person of skill in the art further details for practicing aspects of the present teachings and is not intended to limit the scope of the claims. Therefore, combinations of features disclosed in the detailed description may not be necessary to practice the teachings in the broadest sense, and are instead taught merely to describe particularly representative examples of the present teachings.

In the description below, for purposes of explanation only, specific nomenclature is set forth to provide a thorough understanding of the present disclosure. However, it will be apparent to one skilled in the art that these specific details are not required to practice the teachings of the present disclosure.

Some portions of the detailed descriptions herein are presented in terms of algorithms and symbolic representations of operations on data bits within a computer memory. These algorithmic descriptions and representations are used by those skilled in the data processing arts to effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The required structure for a variety of these systems will appear from the description below. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of an original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

The present disclosure provides a transaction-based hybrid memory module including volatile memory (e.g., DRAM) and non-volatile memory (e.g., flash memory) and a method of operating the same. In one embodiment, the present transaction-based hybrid memory module includes a DRAM cache and a flash storage. In that regards, the hybrid memory module is herein also referred to as a DRAM-flash or DRAM-flash memory module. The DRAM cache is used as a front-end memory cache, and the flash storage is used as a back-end storage. A host memory controller can have a transaction-based memory interface to the hybrid memory module. Memory access requests from a host computer (or a CPU of the host computer) can be asynchronously processed on a transaction basis. The memory access requests can be stored in a buffer and can be processed one at a time. Both the DRAM cache and flash storage can reside on the same memory module, and operate in a single memory address space. The present transaction-based hybrid memory module can provide flash-like memory capacity, power, cost, and DRAM-like performance.

The hybrid memory module can include a dynamic random access memory (DRAM) cache, a flash storage, and a memory controller. The DRAM cache can include one or more DRAM devices and a DRAM controller, and the flash storage can include one or more flash devices and a flash controller. The memory controller can interface with the DRAM controller and the flash controller and can include a buffer and a cache tag. A transaction-based memory interface can be configured to couple the memory controller and a host memory controller. The buffer of the memory controller can store memory transaction requests received from the host memory controller, and the cache tag can indicate that a memory transaction request received from the host memory controller includes a request to access the DRAM cache.

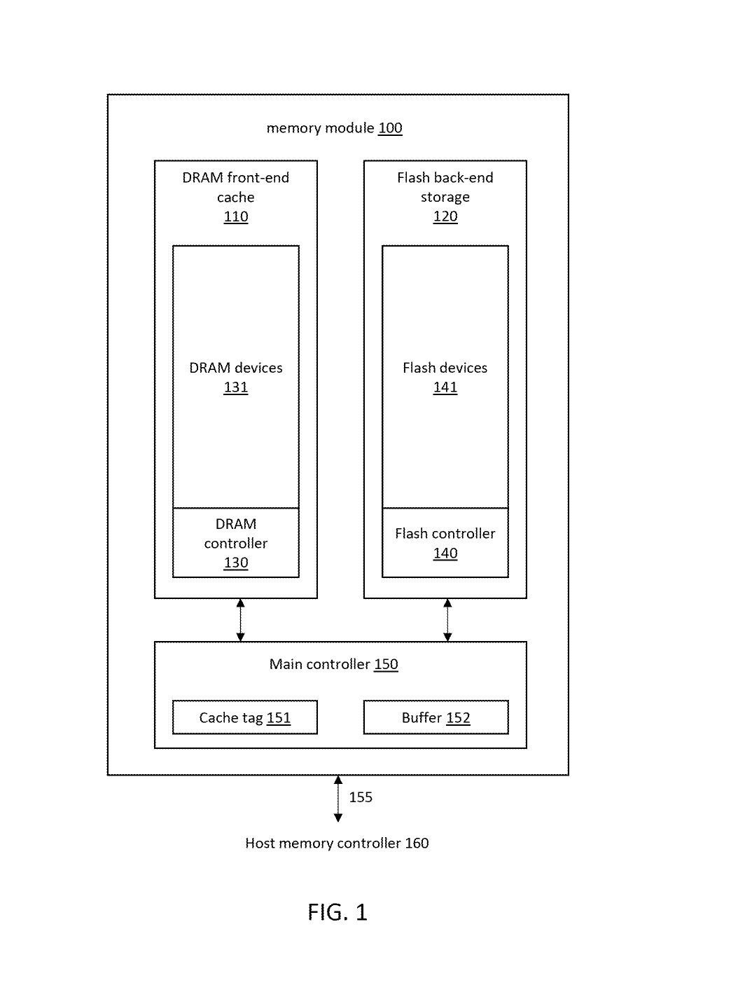

FIG. 1 shows an architecture of an example hybrid memory module, according to one embodiment. A hybrid memory module 100 can include a front-end DRAM cache 110 which can include DRAM devices 131, back-end flash storage 120 including flash devices 141, and a main controller 150 that can interface with a DRAM controller 130 of the DRAM cache 110 and a flash controller 140 of the flash storage 120. The hybrid memory module 100 can interface with a host memory controller 160 via a transaction-based (i.e., asynchronous) memory interface 155. Unlike a synchronous memory interface, the present transaction-based interface can decouple the hybrid memory module 100 from the host memory controller 160, allowing design flexibility. The transaction-based memory interface 155 can be used when a memory access latency of a coupled memory module is non-deterministic.

The main controller 150 can contain a cache tag 151 and a buffer 152 for temporary storage of the cache. The main controller 150 is responsible for cache management and flow control. The DRAM controller 130 can act like a memory controller of the DRAM devices 131 and manage memory transactions and command scheduling as well as DRAM maintenance activities such as memory refresh. The flash controller 140 can act like a solid-state drive (SSD) controller for the flash devices 141 and manage address translation, garbage collection, wear leveling, and scheduling.

The memory transactions and interfaces between the host memory controller 160 and the hybrid memory module 100 will be explained in four use cases with reference to the associated operation flow. The read/write granularity for a flash memory may vary depending on the flash product, for example, 4 KB. The size of a row buffer (or a page) may also vary depending on the DRAM product, for example, 2 KB. In the following examples, it is assumed that the access granularity for the DRAM cache 110 and the flash storage 120 is 64 B and 4 KB, respectively, and the size of a memory controller read/write request is 64 B. However, it is understood that these are just example sizes, and other sizes of the access granularity for the DRAM cache 110 and the flash storage 120 and the size of the memory controller read/write request may be used without deviating from the scope of the present disclosure.

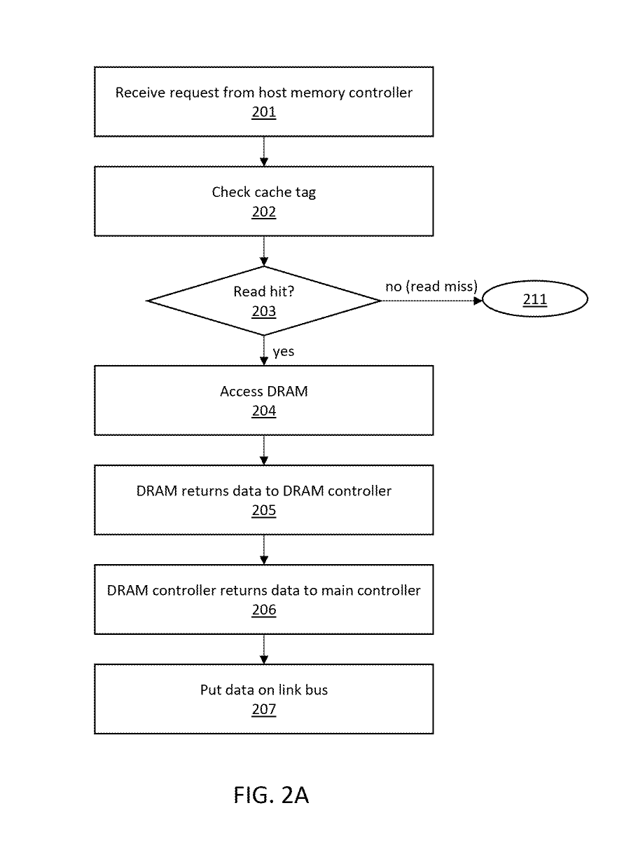

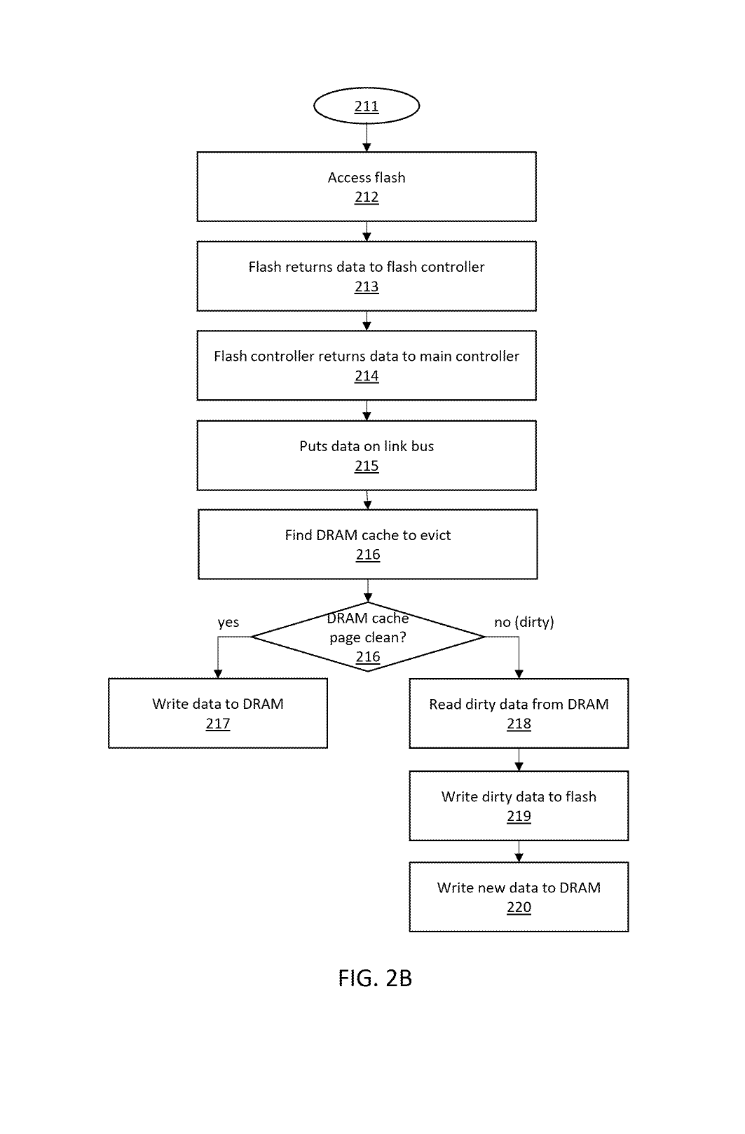

FIG. 2A is an example flowchart for a read hit operation, according to one embodiment. When receiving a request from the host memory controller 160 over the transaction-based memory interface 155 (step 201), the main controller 150 can check the cache tag 151 (step 202). The requests received from the host memory controller 160 can be stored in the buffer 152. The buffer 152 may also store transient data for data transmission between the DRAM cache 110 and the flash storage 120 and between main controller 150 and the host memory controller 160. The cache tag 151 can indicate whether the request contains a memory transaction to and from the DRAM cache 110.

When there is a pending request in the buffer 152, the main controller 150 can decode the request to determine a memory address or a range of memory addresses associated with the request. The main controller 150 can retain certain data (e.g., frequently used data) in the DRAM cache and sets the cache tag 151 to indicate the memory address associated with the retained data. The cache tag 151 can be a decoded number from the memory address and used determine whether a requested data is in the cache. A cache can include multiple cache lines. Each cache line can have its unique index and tag. When a memory request comes in, the decoder (not shown) of the main controller 150 can determine the index and the cache tag associated with the memory address. Based on the index and the cache tag, the cache controller (not shown) of the main controller 150 can determine if any cache line has the same index and cache tag. When there is a match, it is referred to as a cache hit. When there is no match, it is referred to as a cache miss. When the main controller 150 determines by referring to the cache tag 151 that the request includes a read command, and the DRAM cache 110 contains the data associated with the read address, herein referred to as a read hit (step 203), the main controller 150 can instruct the DRAM controller 130 to access the DRAM cache 110. The DRAM controller 130 can access the DRAM cache 110 (step 204) and receive 64 B data from the DRAM cache 110 (step 205). The DRAM controller 130 can then return the 64 B data to the main controller 150 (step 206), and the main controller 150 can send the 64B data to the host memory controller 160 over the link bus (step 207). The timing of the data return from the DRAM cache 110 may be non-deterministic because the interface between the host memory controller 160 and the memory module 100 is transaction-based. The delay of data returned from the DRAM cache 110 and the flash storage 120 may be different, as will be explained in further details below.

FIG. 2B is an example flowchart for a read miss operation, according to one embodiment. When the cache tag 151 indicates that the request from the host memory controller 160 contains a read memory transaction that is not stored in the DRAM cache, then the data can be obtained from the flash storage 120, herein referred to as a read miss (step 211 in FIG. 2A), the main controller 150 can determine that the data is stored in the flash storage 120 and instruct the flash controller 140 to read data from the corresponding memory address on the flash storage 120. The flash controller 140 can access the flash storage 120 (step 212) and receive 4KB data (access granularity of the flash storage 120) from the flash storage 120 (step 213). The flash controller 140 can then return the 4 KB data to the main controller 150 (step 214). The main controller 150 can select the relevant 64 B from the received 4 KB data and send that 64 B (access granularity of the DRAM cache 110) to the host memory controller 160 over the link bus (step 215).

The main controller 150 can further find a DRAM cache page (4 KB) to evict. If the DRAM cache page that corresponds to the 4 KB data is clean (step 216), the main controller 150 can write the 4 KB data to the DRAM controller 130, and subsequently the DRAM controller 130 can write the 4 KB data to the DRAM cache 110 (step 217). The DRAM cache 110 can be updated with the 4 KB data stored in the flash storage 120. Each of the multiple cache lines in a cache can have an index, a tag, and a dirty bit. The main controller 150 can determine the dirtiness of a cache line by referring to the dirty bit. Initially, all dirty bits are set to be 0 meaning that the cache lines are clean. Data in the cache is a subset of data in the flash storage 120. Clean means that for the same address, the data in the cache and the data in the flash storage 120 are the same. Conversely, dirty means that for the same address, the data in the cache is updated from the data in the flash storage 120, therefore the data in the flash storage 120 is stale. When a dirty cache line is evicted, the corresponding data in the flash storage 120 must be updated. When a clean cache line is evicted, no updated is needed.

If the DRAM cache is dirty (step 216), the main controller 150 can instruct the DRAM controller 130 to read the 4KB dirty data from the DRAM cache 110. The DRAM controller 130 can access and receive the 4KB dirty data from the DRAM cache 110 (step 218). The DRAM controller 130 can then return the 4KB dirty data to the main controller 150, and the main controller 150 can instruct the flash controller 140 to write back the 4 KB dirty data to the flash storage 120 (step 219). The main controller 150 can then write the new 4 KB data to the DRAM controller 130, and the DRAM controller 130 can write the new 4 KB data to the DRAM cache 110 (step 220). The DRAM cache 110 can be updated with the new 4 KB data stored in the flash storage 120.

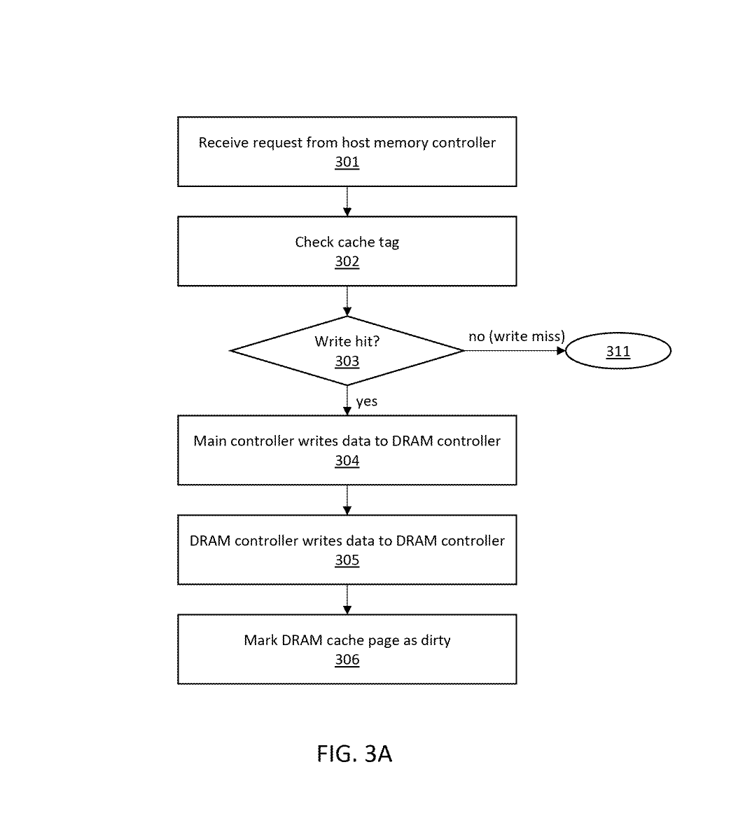

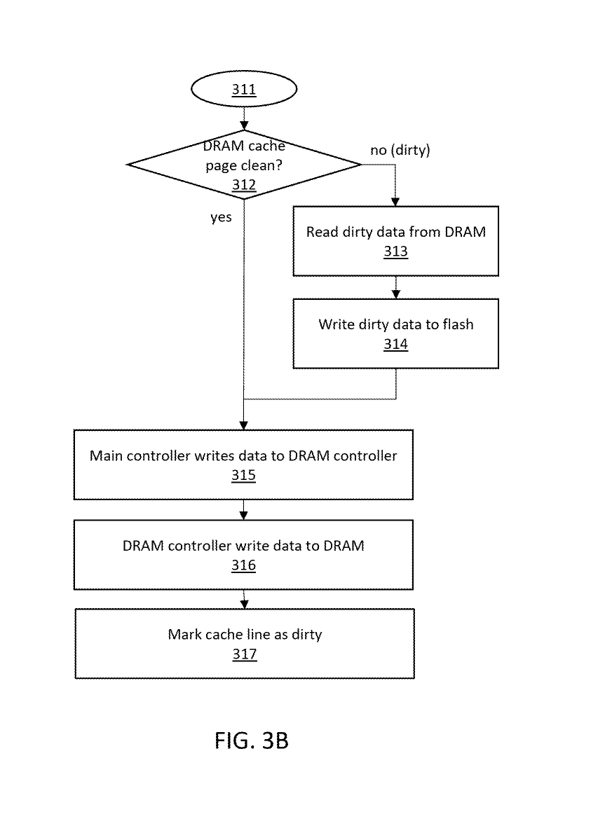

Next, the write hit and write miss operations will be explained with reference to the architecture of the present hybrid memory module 100 of FIG. 1. The example flowcharts described with reference to FIGS. 3A and 3B employ a write-through cache policy. However, it is understood that the present disclosure can employ other cache policies without deviating from the scope of the present disclosure. For a write-through cache policy, a write request is processed synchronously both to the DRAM front-end cache 110 and to the flash back-end storage 120. FIG. 3A is an example flowchart for a write hit operation, according to one embodiment. When receiving a request from the host memory controller 160 over the transaction-based memory interface 155 (step 301), the main controller 150 can check the cache tag 151 (step 302) and determine that the request received from the host memory controller 160 includes a write command to the DRAM cache 110 (step 303), herein referred to as a write hit. In the case of a write hit, the memory transaction can occur in the following sequence. The main controller 150 can write 64 B data received from the host memory controller 160 to the DRAM controller 130 (step 304). The DRAM controller 130 can then write the 64 B data to the DRAM cache 110 (step 305). The main controller 150 can mark the cache page as dirty, and the data in the DRAM cache 110 can be updated (step 306). The cache page marked as dirty can be evicted when a subsequent read miss operation to the cache page occurs in steps 218-220 of FIG. 2B.

FIG. 3B is an example flowchart for a write miss operation, according to one embodiment. The main controller 150 can check the cache tag 151 to determine that the request received from the host memory controller 160 includes a write command to the flash storage 120 (step 311), herein referred to as a write miss. In the case of a write miss, the memory transaction can occur in the following sequence. First, the main controller 150 can determine if the DRAM cache page is clean or dirty (step 312). If the DRAM cache page is dirty, the main controller 150 can instruct the DRAM controller 130 to read 4 KB dirty data from the DRAM cache 110. The DRAM controller 130 can access and receive the 4 KB dirty data from the DRAM cache 110 and return the 4 KB dirty data to the main controller 150 (step 313). The main controller 150 can then write back the 4 KB dirty data to the flash controller 140, and the flash controller 140 can write the 4 KB dirty data to the flash storage 120 (step 314).

When the main controller 150 determines that the DRAM cache page is clean (step 312), or after the dirty data is written to the flash storage (step 314), the main controller 150 is ready to update the data received from the host memory controller 160 in the cache page. The main controller 150 can write 64 B data received from the host memory controller 160 to the DRAM controller 130 (step 315). The DRAM controller 130 can then write the 64 B data to the DRAM cache 110 (step 316). The main controller 150 can mark the cache page as dirty (step 317).

According to some embodiments, the main controller 150 can employ can employ various cache policies without deviating from the scope of the present disclosure. In one embodiment, the main controller 150 can employ a write-back cache policy. When the main controller 150 employs a write-back cache policy, the main controller 150 initially writes to the DRAM front-end cache 110 and can postpone a write to the flash back-end storage 120 until the cache blocks containing the data is modified or replaced by new data. To track the addresses where data has been written over with new data, the main controller 150 mark those overwritten addresses as “dirty,” and the new data is written to the flash back-end storage 120 when the data are evicted from the DRAM front-end cache 110.

In another embodiment, the main controller 150 can employ a write-around cache policy. The write-around cache policy is similar to the write-through cache policy but the data is written directly to the flash back-end storage 120 bypassing the DRAM front-end cache 110. This can reduce the cache being flooded with write requests that will subsequently be re-read.

To achieve better performance and faster response, the present hybrid memory module can map flash pages to DRAM pages. The page mapping between the DRAM cache and the flash storage can allow the present hybrid memory module to employ an open-page policy. The open page policy enables faster memory access when accessing pages in the DRAM cache. For example, when reading data from or writing data to the DRAM cache 110, the present hybrid memory module only needs to do one DRAM row activation, letting the DRAM row buffer stay open, and then can issue a sequence of column accesses taking advantage of the open-page policy. For the DRAM memory, when using the open-page policy, if a sequence of accesses happens on the same row (herein referred to as a row buffer hit), the present transaction-based hybrid memory module can avoid the overhead of closing and reopening rows, thus can achieve better and faster performance.

For the present hybrid memory architecture including both a DRAM memory and a flash memory, the DRAM memory can serve as a cache of the flash memory. The more frequently accessed data can be moved from the flash memory to the DRAM cache, and less frequently accessed data can be moved from the DRAM cache to the flash memory. The frequent movement of the data between the DRAM cache and the flash memory may be costly. To minimize the cost, the present hybrid memory can employ the open-page policy by mapping flash pages to DRAM pages. For example, a flash page of 4 KB can be mapped to two DRAM pages of 2 KB.

According to one embodiment, the present hybrid memory module can support checkpointing. Whenever a checkpoint (e.g., copy data from a DRAM location to a flash location) is made, the main controller 150 can perform data write-back from the DRAM cache 110 to the flash storage 120.

According to one embodiment, the present hybrid memory module can support prefetching. The main controller 150 can fetch multiple flash pages that are highly associated with a particular page to the DRAM cache 110 in advance to improve the performance.

According to one embodiment, a memory module includes a dynamic random access memory (DRAM) cache including one or more DRAM devices and a DRAM controller, a flash storage including one or more flash devices and a flash controller, a memory controller interfacing with the DRAM controller and the flash controller, and a transaction-based memory interface configured to couple the memory controller and a host memory controller.

The memory controller can include a buffer configured to store temporary cache data and a cache tag. The cache tag can indicate that a memory transaction request received from the host memory controller includes a request to access the DRAM cache.

The memory controller can determine that the memory transaction request from the host memory controller is a read hit, a read miss, a write hit, or a write miss based on the cache tag.

The memory controller can map a flash page from the flash storage to one or more DRAM pages of the DRAM cache.

The transaction-based interface can allow the host memory controller to access the memory module when a memory access latency of the memory module is non-deterministic.

The memory controller can determine that a memory transaction request received from the host memory controller is a read request from the DRAM cache or a write request to the DRAM cache based on a cache tag, and the DRAM controller can manage the memory transaction and command scheduling for the DRAM cache in response to the memory transaction request.

The memory controller can determine that a memory transaction request received from the host memory controller is a read request from the flash storage or a write request to the flash storage based on a cache tag, and the flash controller can manage address translation, garbage collection, wear leveling, and scheduling for the flash storage in response to the memory transaction request.

According to one embodiment, a method for operating a hybrid memory module including a DRAM cache and a flash storage can include: asynchronously receiving a memory transaction request from a host memory controller; storing the memory transaction request in a buffer of the hybrid memory module; checking a cache tag of the hybrid memory module and determining that the memory transaction request includes a request to access data stored in the DRAM cache; and performing the memory transaction request based on the cache tag.

The method can further include determining that the memory transaction request is a read request from the DRAM cache based on the cache tag; receiving DRAM data from the DRAM cache that corresponds to the memory transaction request; and providing the DRAM data to the host memory controller.

The method can further include storing the memory transaction requests and the cache tag in the buffer.

The method can further include mapping a flash page from the flash storage to one or more DRAM pages of the DRAM cache.

The method can further include: determining that a memory transaction request is a read request from the DRAM cache or a write request to the DRAM cache based on the cache tag; and managing the memory transaction and command scheduling for the DRAM cache in response to the memory transaction request.

The can further include: determining that a memory transaction request is a read request from the flash storage or a write request to the flash request based on the cache tag; and managing address translation, garbage collection, wear leveling, and scheduling for the flash storage in response to the memory transaction request.

The can further include: determining that a DRAM cache page is dirty; reading dirty data from the DRAM cache page; and writing the dirty data to the flash storage.

The can further include: writing data received from the host memory controller to the DRAM cache; and marking the DRAM cache as dirty.

The can further include: keeping open a DRAM cache page of the DRAM cache; and performing a series of column access to the open DRAM cache page.

The can further include: determining data stored in the flash storage that is a frequently requested by the host memory controller; and mapping the data stored in the flash storage to the DRAM cache based on a frequency of data request by the host memory controller.

An access latency of the DRAM cache and the flash storage is non-deterministic.

The above example embodiments have been described hereinabove to illustrate various embodiments of implementing a system and method for interfacing co-processors and input/output devices via a main memory system. Various modifications and departures from the disclosed example embodiments will occur to those having ordinary skill in the art. The subject matter that is intended to be within the scope of the present disclosure is set forth in the following claims.

What is claimed is:

1. A memory module comprising:
a dynamic random access memory (DRAM) cache including one or more DRAM devices and a DRAM controller;
a flash storage including one or more flash devices and a flash controller;
a memory controller interfacing with the DRAM controller and the flash controller; and
a transaction-based memory interface configured to couple the memory controller and a host memory controller.

2. The memory module of claim 1, wherein the memory controller includes a buffer configured to store temporary cache data and a cache tag.

3. The memory module of claim 2, wherein the cache tag indicates that a memory transaction request received from the host memory controller includes a request to access the DRAM cache.

4. The memory module of claim 3, wherein the memory controller determines that the memory transaction request from the host memory controller is a read hit, a read miss, a write hit, or a write miss based on the cache tag.

5. The memory module of claim 1, wherein the memory controller maps a flash page from the flash storage to one or more DRAM pages of the DRAM cache.

6. The memory module of claim 1, wherein the transaction-based interface allows the host memory controller to access the memory module when a memory access latency of the memory module is non-deterministic.

7. The memory module of claim 1, wherein the memory controller determines that a memory transaction request received from the host memory controller is a read request from the DRAM cache or a write request to the DRAM cache based on a cache tag, and the DRAM controller manages the memory transaction and command scheduling for the DRAM cache in response to the memory transaction request.

8. The memory module of claim 1, wherein the memory controller determines that a memory transaction request received from the host memory controller is a read request from the flash storage or a write request to the flash storage based on a cache tag, and the flash controller manages address translation, garbage collection, wear leveling, and scheduling for the flash storage in response to the memory transaction request.

9. A method for operating a hybrid memory module including a DRAM cache and a flash storage, the method comprising:
asynchronously receiving a memory transaction request from a host memory controller;
storing the memory transaction request in a buffer of the hybrid memory module;
checking a cache tag of the hybrid memory module and determining that the memory transaction request includes a request to access data stored in the DRAM cache; and
performing the memory transaction request based on the cache tag.

10. The method of claim 9, further comprising:
determining that the memory transaction request is a read request from the DRAM cache based on the cache tag;
receiving DRAM data from the DRAM cache that corresponds to the memory transaction request; and
providing the DRAM data to the host memory controller.

11. The method of claim 9, further comprising:
storing the memory transaction requests and the cache tag in the buffer.

12. The method of claim 9, further comprising:
mapping a flash page from the flash storage to one or more DRAM pages of the DRAM cache.

13. The method of claim 9, further comprising:
determining that a memory transaction request is a read request from the DRAM cache or a write request to the DRAM cache based on the cache tag; and
managing the memory transaction and command scheduling for the DRAM cache in response to the memory transaction request.

14. The method of claim 9, further comprising:
determining that a memory transaction request is a read request from the flash storage or a write request to the flash request based on the cache tag; and
managing address translation, garbage collection, wear leveling, and scheduling for the flash storage in response to the memory transaction request.

15. The method of claim 9, further comprising:
determining that a DRAM cache page is dirty;
reading dirty data from the DRAM cache page; and
writing the dirty data to the flash storage.

16. The method of claim 15, further comprising:
writing data received from the host memory controller to the DRAM cache; and
marking the DRAM cache as dirty.

17. The method of claim 9, further comprising:
keeping open a DRAM cache page of the DRAM cache; and
performing a series of column access to the open DRAM cache page.

18. The method of claim 9, further comprising:
determining data stored in the flash storage that is a frequently requested by the host memory controller; and
mapping the data stored in the flash storage to the DRAM cache based on a frequency of data request by the host memory controller.

19. The method of claim 9, wherein an access latency of the DRAM cache and the flash storage is non-deterministic.
